(19) United States
(12) Patent Application Publication
(10) Pub. No.: US 2004/0170832 A1
(43) Pub. Date: Sep. 2, 2004

(54) Use of anionic polymers that carry urethane and/or urea groups for modifying surfaces

(76) Inventors: Valerie Andre, Ludwigshafen (DE); Werner Bertleff, Viernheim (DE); Karl Haberle, Speyer (DE); Helmut Meffert, Ludwigshafen (DE); Kati Schmidt, Ludwigshafen (DE); Wolfgang Schrepp, Heidelberg (DE)

Correspondence Address: Oblon Spivak McClelland, Maier & Neustadt, Fourth Floor, 1755 Jefferson Davis Highway, Arlington, VA, 22202, US

(21) Appl. No.: 10/468,407

(22) PCT Filed: Feb. 28, 2002
(86) PCT No.: PCT/EP02/02201

(30) Foreign Application Priority Data
Mar. 1, 2001 (DE) 101 09 803.0

(51) Int. Cl. B32B 27/02

(52) U.S. Cl. 428/375; 427/385.5; 428/422.8; 428/407

(57) ABSTRACT

The present invention relates to particulate, linear, sheet-like, or three-dimensional structures which comprise, at least on their surface, a hydrophilicizing amount of at least one polymer which has urethane groups and/or urea groups, and also anionic groups.

The present invention relates to particulate, linear, sheet-like, or three-dimensional structures which comprise, at least on their surface, a hydrophilicizing amount of a polymer which has urethane groups and/or urea groups, and also anionic groups. The invention further relates to a polymer obtained from at least one incorporated polyisocyanate and at least one incorporated compound having at least one group reactive toward isocyanate groups and at least one group which is anionic or capable of conversion into an anionic group, and also to a process for modifying the surface properties of particulate, linear, sheet-like, or three-dimensional structures.

Articles made from synthetic materials, such as thermosets or thermoplastics, generally have hydrophobic surface properties. However, hydrophobic properties are frequently undesirable if adhesive, or a coating or ink or paint or lacquer, is to be applied to the articles, since most adhesives, coating compositions and paints give only inadequate adhesion to hydrophobic surfaces. Hydrophobic properties are also undesirable in textile sheets, in particular in nonwovens. Examples of uses of nonwovens are cloths for cleaning, wiping or dishwashing, and serviettes. In these applications it is important that when spilled liquids, for example, such as milk, coffee, etc. are wiped up they are rapidly and fully absorbed, and that wet surfaces are dried as fully as possible. The absorption of liquids by a cleaning cloth becomes more rapid as their transport on the fiber surface becomes faster, and fibers with a hydrophilic surface are readily and rapidly wetted by aqueous liquids.

There are various conventional processes for hydrophilicizing the surfaces of films or moldings. For example, the surfaces of plastic items can be activated by gaseous fluorine. However, this process requires operations using the highly poisonous gas fluorine, with increased apparatus costs. Corona and plasma treatments are other processes used to increase the hydrophilic character of the surface of various materials, such as plastics or metals.

To improve the water-absorption properties of nonwovens, use is also made of surface-active hydrophilicizing agents, such as emulsifiers, surfactants, or wetting agents. These give excellent initial hydrophilic properties. However, a disadvantage of these nonwovens is that the hydrophilic agents are gradually washed out by water or other aqueous media.

After repeated contact with water, the product becomes increasingly hydrophobic. Another disadvantage of the known surface-active agents is a marked reduction in the surface tension of water so that in many applications, in particular in nonwovens used for sanitary or diaper applications, there is an undesirable increase in the susceptibility to permeation and in the wetting power of the liquid absorbed.

WO 98/27263 discloses stably hydrophilic polymer coatings for fibers made from polyester or from polypropylene or the like. The coating comprises certain polyoxypropylamines or polypropylene oxide polymers or hydrophilic polyester copolymers containing ethylene terephthalate units.

WO 97/00351 describes durably hydrophilic polymer coatings for polyester fibers, polyethylene fibers, or polypropylene fibers, and for the corresponding woven fabrics. The coatings comprise hydrophilic copolyesters, and also polypropylene oxide polymers.

The unpublished German patent application P 100 29 026.4 describes the use, for modifying surfaces, of cationic polymers which have urethane and/or urea groups.

It is an object of the present invention to provide particulate, linear, sheet-like, or three-dimensional structures provided with hydrophilic properties, and also a process for increasing the level of surface hydrophilic properties of structures of this type.

This object is achieved by way of a particulate, linear, sheet-like, or three-dimensional structure comprising, at least on its surface, a hydrophilicizing amount of at least one polymer which has urethane groups and/or urea groups, and also anionic groups, where the content of urethane and/or urea groups is at least 2 mol/kg of polymer.

Preferred embodiments of the structure of the invention are linear or sheet-like textiles. Other preferred embodiments of the structure of the invention are plastic films and plastic moldings.

For the purposes of the present invention, particulate structures encompass the range from fine pigments to macroscopic particles. They particularly include those with a particle size of from 1 nm to 10 mm, in particular from 10 nm to 1 mm, which are preferably dispersed or dispersible in a medium. Examples which may be mentioned are pigments, mineral or metallic fillers, and nonliving organic materials.

For the purposes of the present invention, “linear structures” are particularly fibers, filaments, yarns, threads, and the like.

“Sheet-like structures” are particularly wovens, knits, felts, webs, or nonwovens, preferably the latter. A nonwoven is produced by laying down a web of fibers which is then consolidated by various processes to give nonwovens. For example, the web is treated with an aqueous binder, such as a polymer latex, and then, where appropriate after removal of excess binder, dried and, where appropriate, cured. Other sheet-like structures are films, paper, and comparable two-dimensional structures.

For the purposes of the present application, sheet-like textile structures also include textile composites, e.g. carpets, backed textiles, laminated textiles, etc.

Three-dimensional structures are generally moldings of various dimensions. They include in particular moldings made from wood, from paper, from metals, from plastics, from ceramic substrates, and from woven fabrics composed of natural or synthetic fibers in the form of fluffs, tissues, etc.

Preferred embodiments of the structure of the invention are linear or sheet-like textile structures. Other preferred embodiments of the structure of the invention are plastic films and plastic moldings.

The structures used according to the invention preferably encompass at least one natural or synthetic polymeric material.

Examples of suitable polymeric materials are polymers with substantially hydrophobic surface properties, obtainable by free-radical polymerization of monomers having at least one ethylenically unsaturated double bond. Examples of suitable monomers are those selected from the group consisting of esters of α,β-ethylenically unsaturated mono- or dicarboxylic acids with monohydric alcohols, amides of α,β-ethylenically unsaturated monoor dicarboxylic acids with N-alkyl- or N,N-dialkylamines, esters of vinyl alcohol or allyl alcohol with monocarboxylic acids, vinyl ethers, vinylaromatics, vinyl halides, vinylidene halides, (meth)acrylonitrile, mono- and diolefins, and mixtures of these. Other suitable polymeric materials are polyamides, polyesters, aldehyde resins, epoxy resins, and polyurethanes. The polymeric materials may be used separately or in the form of mixtures.

Preferred polymeric materials are:

1. Polymers of mono- or diolefins, for example polyethylene, polypropylene, polyisobutylene, poly-1-butene, poly-4-methyl-1-pentene, polyisoprene, and polybutadiene, and also polymers of cyclolefins, e.g. of cyclopentene or norbornene;

2. copolymers of mono- or diolefins with one another or with at least one other of the abovementioned ethylenically unsaturated monomers;

3. vinylaromatics, in particular polystyrene, poly(p-methylstyrene), and poly(α-methylstyrene);

4. copolymers of vinylaromatics, such as styrene or α-methylstyrene, e.g. with dienes or with acrylics, for example styrene-butadiene, styrene-acrylonitrile, styrene-alkyl (meth)acrylate, styrene-butadiene-alkyl (meth)acrylate, styrene-maleic anhydride, styrene acrylonitrile-methyl (meth)acrylate;

5. graft copolymers of vinylaromatics, such as styrene or α-methylstyrene, e.g. styrene onto polybutadiene;

6. halogen-containing homo- or copolymers, e.g. of vinyl halides or of vinylidene halides;

7. polymers which derive from α,β-unsaturated acids or from derivatives of these, for example polyacrylates, poly(meth)acrylates, poly(meth)acrylamides, and poly(meth)acrylonitriles;

8. polyurethanes with substantially hydrophobic surface properties;

9. polyamides and copolyamides which derive, for example, from diamines and dicarboxylic acids, and/or from aminocarboxylic acids, or from the corresponding lactams, such as nylon-4, nylon-6, nylon-6,6, -6,10, -6,9, -6,12, -4,6, -12,12, nylon-11, nylon-12, aromatic polyamides, etc.;

10. polyureas, polyimides, polyamideimides, polyetherimides, polyesterimides, polyhydantoins, and polybenzimidazoles;

11. polyesters which derive from dicarboxylic acids and from dialcohols, and/or from hydroxycarboxylic acids, and/or from the corresponding lactones;

12. polycarbonates and polyester carbonates;

13. crosslinked polymers which derive from aldehydes on the one hand and from phenols, urea, or melamine on the other, for example phenol-formaldehyde resins, urea-formaldehyde resins, and melamine-formaldehyde resins;

14. crosslinkable acrylic resins which derive from substituted acrylates, e.g. from epoxyacrylates, from urethane acrylates, or from polyester acrylates;

15. epoxy resins which derive, for example, from aliphatic, cycloaliphatic, heterocyclic, or aromatic glycidyl compounds, e.g. products from diglycidyl ethers of bisphenol A;

16. binary or multiple-component blends (polyblends) of the abovementioned polymers.

Preference is given to those particulate, linear, sheet-like or three-dimensional structures which encompass at least one polymeric material selected from the group consisting of polyolefins, polyesters, polyamides, polyacrylonitrile, polyaromatics, styrene-acrylonitrile copolymers (SAN), acrylonitrile-butadiene-styrene copolymers (ABS), polyurethanes, and mixtures (polymer blends) of the abovementioned polymers.

Preferred structures used according to the invention are synthetic fibers, particularly made from polyolefins, such as polyethylene or polypropylene, copolymers of monoolefins with one another or with other ethylenically unsaturated monomers, polyesters, polyacrylonitrile, or polyamides, e.g. nylon-6 or nylon-6,6.

Preferred structures used according to the invention are sheet-like structures, and in particular films or foils. These preferably encompass a polymer selected from the group consisting of polyolefins, such as polyethylene and/or polypropylene, polymers of halogenated monomers, e.g. polyvinyl chloride and/or polytetrafluoroethylene, polyesters and mixtures of these.

Another preferred structure used according to the invention is a molding. This preferably encompasses at least one polymeric material selected from the group consisting of polyolefins, e.g. polyethylene and/or polypropylene, polyaromatics, such as polystyrene, polymers of halogenated monomers, for example polyvinyl chloride and/or polytetrafluoroethylene, polyesters, polyacrylonitrile, styrene-acrylonitrile copolymers, acrylonitrile-butadiene-styrene copolymers,. polyamides, such as nylon-6 and/or nylon-6,6, polyurethanes and mixtures of these. According to the invention, for modifying the surface properties use is made of at least one polymer which has urethane groups and/or urea groups, and also anionic groups.

Preference is given to polymers obtained from

a) at least one polyisocyanate,

b) at least one compound having at least one group reactive toward isocyanate groups and also having at least one group which is anionic or capable of conversion into an anionic group,

and also, where appropriate, from at least one other compound which differs from b) and has at least one group reactive toward isocyanate groups. This polymer always contains some anionic (negatively charged) groups. Groups with anionic charge can be produced from those (uncharged) groups capable of conversion into anionic groups in the compounds of component b) and/or in the polymer, by deprotonation. At least some of the initial groups capable of conversion into anionic groups in the polymer are then present in the form of the products of their reaction with at least one neutralizing (deprotonating) agent.

The polyisocyanates a) are preferably those selected among compounds having from 2 to 5 isocyanate groups, isocyanate prepolymers having an average number of from 2 to 5 isocyanate groups, oligomers of di- or of polyisocyanates having free NCO groups, for example compounds having isocyanurate groups, biuret groups, and/or allophonate groups, and mixtures of these. Other suitable compounds are those which in addition or instead of free isocyanate groups have functional groups which liberate isocyanate groups or react like isocyanate groups. Examples of these are compounds having capped isocyanate groups or uretdione groups. The compounds having isocyanurate groups are in particular simple triisocyanatoisocyanurates, i.e. cyclic trimers of diisocyanates, or mixtures with their higher homologs having more than one isocyanurate ring. Compounds having biuret groups may be obtained by an addition reaction of three molecules of diisocyanate onto one molecule of water, for example. Capped isocyanate groups are produced during reaction with a blocking agent, which liberates the isocyanate groups again when the blocked isocyanate groups are heated to a temperature at least equal to what is known as the deblocking temperature. Compounds which block (cap or protect) isocyanate groups are the usual compounds known to the skilled worker. Examples of these are phenols, caprolactam, imidazoles, pyrazoles, pyrazolines, 1,2,4-triazoles, diketopiperazines, malonic esters, and oximes.

It is preferable to use aliphatic, cycloaliphatic, or aromatic diisocyanates as components a). Suitable aliphatic diisocyanates then preferably have a hydrocarbon radical having from 4 to 12 carbon atoms. Suitable cycloaliphatic or aromatic diisocyanates preferably have a cycloaliphatic or aromatic hydrocarbon radical having from 6 to 15 carbon atoms, or an araliphatic hydrocarbon radical having from 7 to 15 carbon atoms. Examples of suitable diisocyanates are tetramethylene diisocyanate, hexamethylene diisocyanate, 2,3,3-trimethylhexamethylene diisocyanate, dodecamethylene diisocyanate, 1,4-cyclohexylene diisocyanate, isophorone-diisocyanate, dicyclohexylmethane diisocyanate, 2,2-bis(4-isocyanatocyclohexyl)propane, phenylene 1,4-diisocyanate, tolylene 2,4- and 2,6-diisocyanate, and isomeric mixtures of these (e.g. 80% of 2,4-isomer and 20% of 2,6-isomer), naphthylene 1,5-diisocyanate, diphenylmethane 2,4and 4,4′-diisocyanate, o- and m-xylylene diisocyanate, tetramethylxylylene diisocyanate, the isomers of bis(4-isocyanatocyclohexyl)methane, e.g. the trans/trans, cis/cis, and cis/trans isomers, and also mixtures of these. Diisocyanate mixtures whose use is preferred are the isomericmixtures of tolylene diisocyanate and diphenylmethane diisocyanate, and in particular a tolylene diisocyanate isomeric ixture of about 80% of 2,4-isomer and about 20% of 2,6-isomer. Preference is also given to mixtures which encompass at least one aromatic and at least one aliphatic and/or cycloaliphatic diisocyanate. The mixing ratio here of aliphatic and/or cycloaliphatic to aromatic diisocyanates is preferably in the range from about 4:1 to 1:4. Particular preference is given to mixtures which comprise tolylene 2,4- and/or 2,6-diisocyanate, and also hexamethylene diisocyanate and/or isophorone diisocyanate. An example of a suitable triisocyanate is triphenylmethane 4,4′,4″-triisocyanate. Other suitable materials are isocyanate prepolymers and polyisocyanates obtainable by addition reactions of the abovementioned diisocyanates onto polyfunctional hydroxyl- or amine-group-containing compounds. Examples of these are the low-molecular-weight adducts of 3 mol of diisocyanate, such as hexamethylene diisocyanate, isophorone diisocyanate, etc., onto trihydric alcohols, e.g. trimethylolpropane, having a molar mass generally not above 400 g/mol. Preference is given to the use of hexamethylene diisocyanate, isophorone diisocyanate, or a mixture of these.

In the compounds of component b), the groups reactive toward isocyanate groups are preferably those selected among hydroxyl groups, primary and secondary amino groups, and thiol groups. Depending on these groups, the resultant polymers have urethane groups, urea groups, and/or thiocarbamate groups.

The groups which are anionic or are capable of conversion into an anionic group are preferably carboxylic acid groups, phosphonic acid groups, phosphoric acid groups, and/or sulfonic acid groups, or reaction products of these with at least one neutralizing agent. Preference is given to hydroxyalkylcarboxylic acids and dihydroxyalkylcarboxylic acids, where the alkyl radicals preferably have from 1 to 10 carbon atoms. Examples of suitable hydroxycarboxylic acids are hydroxyacetic acid (glycolic acid), hydroxypropionic acid (lactic acid), hydroxysuccinic acid (malic acid). The-salts of these acids are also suitable. Preferred dihydroxyalkylcarboxylic acids are 2,2-di(hydroxymethyl)alkylcarboxylic acids of the formula

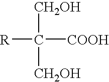

where R is hydroxymethyl, hydrogen, or C₁-C₂₀-alkyl. Examples of these include 2,2-di(hydroxymethyl)acetic acid, 2,2,2-tri(hydroxymethyl)acetic acid, 2,2-di(hydroxymethyl)propionic acid (DMPA), 2,2-di(hydroxymethyl)butyric acid, 2,2-di(hydroxymethyl)pentanoic acid, etc. It is preferable to use 2,2-di(hydroxymethyl)propionic acid (dimethylolpropionic acid, DMPA).

Examples of suitable compounds b) which have at least one sulfonic acid group or sulfonate as polar functional group are diesterdiols and polyesterdiols, with aliphatic, cycloaliphatic, or aromatic diols, of dicarboxylic acids which also have at least one sulfonic acid group or metal sulfonate group. Examples of the dicarboxylic acids which may be used here are sulfosuccinic acid, 4-sulfophthalic acid, 5-sulfoisophthalic acid, sulfoterephthalic acid, 4-sulfonaphthalene-2,7-dicarboxylic acid, 5-(4-sulfophenoxy)terephthalic acid, and the corresponding metal sulfonates. Other suitable compounds b) which have at least one sulfonic acid group or sulfonate group are appropriate substituted straight-chain or branched aliphatic, cycloaliphatic, or aromatic diols. Examples of these include 2-sulfo-1,4-butanediol, 2,5-dimethyl-3-sulfo-2,5-hexanediol, and the sodium and potassium salts of these.

Use may also be made of compounds b) of the formulae

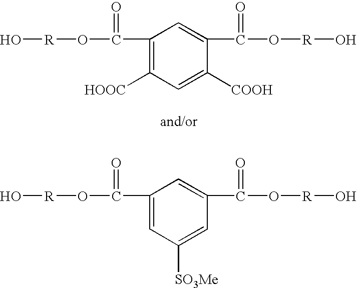

where each R is C₂-C₁₈-alkylene and Me is Na or K.

Other compounds which may be used according as component b) are those of the formulae

H₂N(CH₂)ₙ—NH—(CH₂)ₘ—COO⁻M⁺

H₂N(CH₂)ₙ—NH—(CH₂)ₘ—SO₃⁻M⁺

where m and n, independently of one another, are an integer from 1 to 8, in particular from 1 to 6, and M is hydrogen, Li, Na, K, or ammonium. m and n in the compounds are preferably 2.

Suitable compounds b) having at least one thiol group are compounds of the type which derive from the abovementioned compounds b) having at least one hydroxyl group by way of (formal) replacement of one or, where possible, some or all of the OH groups by SH.

Examples of suitable compounds b) having at least one primary and/or secondary amino group reactive toward isocyanate groups are aminocarboxylic acids, such as lysine, alanine, valine, etc., aminosulfonic acids, etc.

Other suitable compounds b) are the adducts, described in DE-A-20 34 479, of aliphatic diamines having two primary amino groups onto a,p-unsaturated carboxylic acids. The predominant product is N-aminoalkylaminoalkanecarboxylic acids, e.g. N-(2-aminoethyl)-2-aminoethanecarboxylic acids. The alkanediyl units here preferably have from 2 to 6 carbon atoms. The entire scope of DE-A-20 34 479 is incorporated herein by way of reference.

When compounds b) are used having only one group reactive toward isocyanate groups, the selection of the amount used is preferably such that the resultant polymers have a molar mass of at least 1000 g/mol.

Suitable compounds b) having one group reactive toward isocyanate groups are the abovementioned monohydroxycarboxylic acids, and also monothio and monoamino acids.

When compounds b) are used having groups capable of conversion into anionic groups, the partial or complete conversion into anionic groups may take place prior to, during, or after the isocyanate polyaddition stage. The anionic groups are preferably present as the alkali metal salts or ammonium salts. Suitable neutralizing agents are alkali metal bases, such as sodium hydroxide solution, potassium hydroxide solution, soda, sodium hydrogencarbonate, potassium carbonate, or potassium hydrogencarbonate, or also ammonia or amines. Examples of suitable amines are C₁-C₆-alkylamines, such as n-propylamine and n-butylamine, dialkylamines, and trialkylamines, such as diethylpropylamine, dipropylmethylamine and triethylamine etc.

In addition to components a) and b), the polymers used according to the invention may incorporate other components conventionally used for preparing polyurethanes and, respectively, polyureas. Examples of these are compounds other than component b) having at least two groups reactive toward isocyanate groups and conventionally used as chain extenders.

The additional components of the polymers are preferably diols, diamines, amino alcohols, or a mixture of these. The molecular weight of these compounds is preferably in the range from about 56 to 500.

It is preferable for the additional component used to be diols. Examples of diols which may be used are ethylene glycol, propylene glycol, butylene glycol, neopentyl glycol, cyclohexanedimethylol, di-, tri-, tetra-, penta- or hexaethylene glycol, and mixtures of these.

Examples of suitable additional amino alcohols are 2-aminoethanol, 2-(N-methylamino)ethanol, 3-aminopropanol, 4-aminobutanol, 1-ethylamino-2-butanol, 2-amino-2-methyl-1-propanol, 4-mrethyl-4-amino-2-pentanol, etc.

Examples of suitable additional diamines are ethylenediamine, propylenediamine, 1,4-diaminobutane, 1,5-diaminopentane, and 1,6-diaminohexane.

Other suitable diamines are those of the formula R^{a}—NH—(CH₂)₂₋₃—NH₂, where R^{a} is C₈-C₂₂-alkyl or C₈-C₂₂-alkenyl, and the alkenyl radical may have 1, 2 or 3 non-adjacent double bonds. The molecular weight of these diamines is preferably in the range from about 160 to 400.

Examples of other suitable diamines which are conventionally used as chain extenders are hexamethylenediamine, piperazine, 1,2-diaminocyclohexane, 1,3-diaminocyclohexane, 1,4-diaminocyclohexane, neopentanediamine, 4,4′-diaminodicyclohexylmethane, etc.

The abovementioned additional components may be used individually or as a mixture. It is preferable to use no chain extenders.

The polymers used according to the invention may also incorporate at least one other compound with one group (terminator) reactive toward isocyanate groups. This group is preferably hydroxyl, or primary or secondary amino. Examples of suitable compounds with one group reactive toward isocyanate groups are monofunctional alcohols, such as methanol, ethanol, n-propanol, isopropanol, etc. Other suitable compounds are amines having one primary or secondary amino group, e.g. methylamine, ethylamine, n-propylamine, isopropylamine, dimethylamine, diethylamine, di-n-propylamine, diisopropylamine, etc. Other suitable terminators are those which have one group reactive toward isocyanate groups and at least one tertiary amino or ammonium group. Examples of these are N,N-dialkylamino alcohols and N,N-dialkylamino amines.

Preference is given to the use of polymers which have a number-average molecular weight in the range from about 1000 to 50000, preferably from 2000 to 20000.

The polymers preferably have a content of from 0.1 to 5 mol/kg, preferably from 0.5 to 3 mol/kg, in particular from 1 to 3 mol/kg, of anionic groups. No account is taken here of any groups which may be capable of conversion into anionic groups in the polymer.

The content of urethane groups and/or urea groups is preferably at least 2.5 mol/kg, particularly preferably at least 3 mol/kg, in particular at least 4 mol/kg. The maximum content of urethane groups and/or urea groups is not particularly critical, being, 10 mol/kg for example, preferably 8 mol/kg.

The invention also provides a polymer obtained from

a) at least one polyisocyanate,

b) at least one compound having at least one group reactive toward isocyanate groups and also having at least one group which is anionic or capable of conversion into an anionic group,

and also, where appropriate, from at least one other compound which differs from b) and has at least one group reactive toward isocyanate groups, where component b) has at least one compound having at least one anionic group, or where at least some of the groups capable of conversion into anionic groups in the polymer are present in the form of the products of their reaction with at least one neutralizing agent, and where the content of urethane groups and/or urea groups in the polymer is at least 2 mol/kg of polymer.

In relation to preferred components a) and b), molar masses, contents of urethane and/or urea groups, and contents of anionic groups in the polymers of the invention, reference is made to the description of polymers used according to the invention.

Preference is given to polymers which are composed solely of compounds of components a) and b).

The polymers of the invention and the polymers used according to the invention are prepared by reacting at least one polyisocyanate a) with at least one compound of component b), and also, where appropriate, with additional compounds having groups reactive toward isocyanate groups. The ratio here of NCO equivalent of component a) to active hydrogen atom equivalent of components b) and, where appropriate, of additional compounds is generally in the range from about 0.6:1 to 1.4:1, preferably from 0.9:1 to 1.1:1, in particular from 0.9:1 to 1:1. The reaction may take place without solvent or in a suitable inert solvent or solvent mixture. Preference is given to solvents with unlimited miscibility with water. Preference is further given to solvents which have a boiling point in the ranae from about 40 to 100° C. at atmospheric pressure. Aprotic polar solvents are suitable, for example tetrahydrofuran, ethyl acetate, N-methylpyrrolidone, dimethylformamide, dimethylacetamide, and preferably ketones, such as acetone or methyl ethyl ketone. If desired, the reaction may take place in an atmosphere of inert gas, e.g. under nitrogen. The reaction moreover preferably takes place at ambient pressure or at superatmospheric pressure, in particular at the pressure generated by the reactants themselves under the reaction conditions. The reaction temperature is preferably in the range from about 20 to 180° C., in particular from 50 to 150° C. If the component b) used and also, where appropriate, additional components used are predominantly compounds whose groups reactive toward isocyanate groups are primary and/or secondary amino groups, the reaction may, if desired, take place in a solvent or solvent mixture which may have active hydrogen atoms. Besides the abovementioned compounds, use is then preferably made of alcohols, such as methanol and ethanol, mixtures of alcohols and water, mixtures of ketones and water, or else mixtures of alcohols and the abovementioned ketones. If the resultant polymers still have free isocyanate groups, these may finally be rendered inactive. The reaction time may be in the range from a few minutes to some hours. The reaction may be carried out in the presence of conventional catalysts, such as dibutyltin dilaurate, tin(II) octoate, or diazabicyclo[2.2.2]octane. Suitable polymerization apparatus is known to the skilled worker. Examples of this are stirred tanks, if desired equipped with devices to dissipate the heat of reaction. If use is made of an organic solvent in preparing the polymers, this may then be removed by conventional processes known to the skilled worker, e.g. by distillation at reduced pressure. It is also possible to add water to the polymer prior to separating off the solvent.

High-boiling solvents may, if desired, also remain in the solution, but the proportion of these should preferably be not above 10% by weight, based on the weight of the polymer.

The polymers may be used in mixtures or in combination with surface-active substances, e.g. anionic, nonionic, or cationic surfactants or, respectively, wetting agents. They may also be used in a mixture with other polymers, and this can in some circumstances also strengthen the surface-modifying action.

The polymers of the invention and the polymers used according to the invention having urethane groups and/or urea groups and anionic groups are advantageously suitable for modifying the surface properties of particulate, linear, sheet-like, or three-dimensional structures. For the purposes of the present invention, the expression “modifying the surface properties” is interpreted widely. This includes especially hydrophilicization, which for the purposes of the present invention is generally an increase in the wettability with water or with an aqueous liquid. Increased wettability is usually attended by more rapid and/or increased absorption of liquid and/or by improved retention of liquid, generally also under superatmospheric pressure. However, according to the invention “modifying of surfaces” also includes an improvement in adhesion, an improved antistatic effect, an anti-deposition effect, improved properties for the wearer, e.g. in the case of sanitary products, and/or improved hand.

The structures of the invention are generally advantageously suitable for any application sector where water or-aqueous liquids come into contact with materials which in their unmodified state are substantively hydrophobic. Particularly relevant factors here are the rapid absorption and/or the rapid transport of water into materials which are in themselves hydrophobic. The structures of the invention may moreover generally be used advantageously wherever modifying surfaces by hydrophilicization can achieve improved adhesion properties, improved antistatic properties, improved anti-deposition properties, improved hand and/or improved wearer comfort.

The structures of the invention are advantageously suitable in or as synthetic fibers, wovens, knits, nonwovens, felts, textile composites, e.g. carpets, backed or laminated textiles, etc. They are also advantageously suitable for use in diapers, sanitary pads, cloths for cleaning, wiping or dishwashing, and serviettes, agricultural textiles, geotextiles, and also for filter applications.

The polymers of the invention and the polymers used according to the invention are suitable as hydrophilicizing agents for the abovementioned materials, in particular for synthetic fibers, for example those made from polyethylene, polypropylene, copolymers of monoolefins with one another or with at least one other free-radical-polymerizable monomer, polyesters, polyacrylonitrile, or from polyamides. The polymers are also suitable for improving the printability and adhesive bondability of sheeting or films, for example those made from polyethylene, polypropylene, polyvinyl chloride, polytetrafluoroethylene, or from polyesters.

The antistatic properties of sheeting or films can also be improved by using the polymers.

The use of the polymers in association with moldings also gives an improvement in surface properties, making these more printable or more adhesive-bondable and giving them better antistatic properties. Examples of typical moldings are those made from polyethylene, polypropylene, polystyrene, polyvinyl chloride, polytetrafluoroethylene, polyesters, polyacrylonitrile, styrene-acrylonitrile copolymers (SAN), acrylonitrile-butadiene-styrene terpolymers (ABS), polyamides, such as nylon-6 or nylon-6,6, or from polyurethanes and/or mixtures of the abovementioned plastics.

The use of polymers having urethane groups and/or urea groups and anionic groups also leads to an improvement in the surface conductivity of hydrophobic, non-conducting materials, in particular of the abovementioned plastics, and thus improves their antistatic properties. The polymers are also suitable for reducing the susceptibility of plastic films to deposition.

Another advantage of the agents of the invention compared with known hydrophilicizing agents is that they do not lead to any significant reduction in the surface tension of water.

The processes used to equip the particulate, linear, sheet-like or three-dimensional structures of the invention with the polymers may be those usually used to hydrophilicize the abovementioned structures with hydrophilicizing agents of the prior art. To this end, the structure is usually treated with a dilute, preferably aqueous solution of the polymer in a manner usual for the nature of the structure, e.g. by rinsing, dipping, spraying, padding, or similar methods as usually used for treating textiles or films. The content of polymer in the solution is generally in the range from at least 0.01 to 20% by weight, and preferably from 0.1 to 10% by weight, based on the weight of the solution. It is preferable to use aqueous solutions of the polymers for the treatment. The required amount of polymer for hydrophilicization is absorbed by the surface and remains adhering thereto after drying. The amounts required to achieve effective hydrophilicization are reached automatically and are extremely small. For structures with a smooth surface, such as films or similar structures, as little as 0.1 mg/m² of polymer is sufficient.

In another embodiment of the process of the invention for hydrophilicizing surfaces, the polymer may also be added to the material of which the structure is composed and the structure may then be produced from this. For example, when treating thermoplastics, the polymer in the form of a solid may be compounded with the plastic. The resultant treated plastic is then further processed by conventional processes to give films, for example by extrusion, or to give fiber materials, for example by a melt spinning processes.

The ease of use of the polymers of the invention and the polymers used according to the invention permits their use in many application sectors, for example as hydrophilicizing agents for nonwovens used in diapers, hygiene inserts, agricultural textiles, geotextiles, other textiles, or filter systems, for example. The synthetic fibers treated with the polymers may themselves be further processed to give textiles. The hydrophilicization usually also results in an improvement in water-vapor permeability and capillary transport of perspiration, and a reduction in soiling by a wide variety of hydrophobic types of dirt. In addition, there is a favorable effect on soil release properties. The polymers may also be used as an antistatic treatment for plastic films or silicon wafers.

A suitable measure for assessing the hydrophilic/hydrophobic nature of the surface of a particulate, linear, sheet-like or three-dimensional structure is the contact angle of water on the respective surface (see, for example, Römpp, Lexikon Chemie, 9th Edition, p. 372 “Benetzung”, Georg Thieme Verlag (1995)). The term hydrophobic surfaces is usually used here if the contact angle of water is above 90°. The use of at least one polymer having urethane groups and/or urea groups and ammonium groups brings about a reduction in the contact angle by at least 10°, preferably by at least 30°, compared with that of the unmodified hydrophobic surface.

It is advantageous that the structures of the invention do not usually show the unfavorable effects known from the prior art on the surface tension of aqueous solutions, nor any increased susceptibility to migration.

The polymers used according to the invention, and also the structures surface-modified with the same, advantageously have particularly good compatibility with polymer melts. They are therefore generally also suitable as additives to a melt of polymeric raw materials for fibers or for moldings. However, the polymers may also be used as agents for modifying the structures by post-treatment.

The invention is further illustrated by the following non-limiting examples.

### EXAMPLES

### I. Test Methods

I.1 Angle of Contact Measurement

The respective substrate is treated, with stirring, with a 0.5% strength by weight solution of the polymer for 30 min at 21° C. The specimen is dried immediately after treatment and the contact angle is determined using distilled water at room temperature.

I.2 Measurement of Hydrophilic Properties

The measurement took place on a polypropylene web. The web is treated with a aqueous 0.5% strength by weight solution of the polymer, and then dried. A drop of water is applied to the substrate to be tested. The wetting of the web by the water is assessed visually by way of a 10 point scale. Zero points here means no wetting, and 10 points means immediate run-out of the drop.

I.3 Reflectometric Determination of Affinity

A 0.01% strength by weight solution of the polymer is adjusted to pH 7. A polypropylene film applied to a silicon wafer is impacted perpendicularly at room temperature with this solution at flow rate 0.7 ml per minute. The adsorption of the polymer alters the detection signal from that for a polymer-free solution. This alteration is input into a computer-based model of the jet to give a coating weight.

### II. Preparation Examples

### Example 1

### Polyurea made from Isophorone Diisocyanate and the Michael Adduct of Ethylenediamine and Sodium Acrylate

82.0 G (0.20 mol) of a 40% strength aqueous solution of the Michael adduct of ethylenediamine and sodium acrylate (essentially consisting of sodium 2-aminoethyl-2-aminoethanecarboxylate) are dissolved in a mixture of 200 g of acetone and 200 g of water in a four-necked flask equipped with stirrer, dropping funnel, thermometer, and reflux condenser. 44.4 g (0.2 mol) of isophorone diisocyanate were added dropwise to the mixture in such a way that the temperature did not exceed 30° C. The reaction mixture was stirred at 50° C. for 2 hours, and then the acetone was distilled off at subatmospheric pressure. This gave a polyurea solution with solids content of 23.0% by weight and a calculated content of 5.18 mol/kg of urea groups and a content of 2.59 mol/kg of anionic groups.

### Example 2

### Polyurea made from Isophorone Diisocyanate and Sodium 2-aminoethyl-2-aminoethanesulfonic acid

A polyurea was prepared from 84.0 g (0.2 mol) of sodiuir 2-aminoethyl-2-aminoethanesulfonate and 44.4 g (0.2 mol) of isophorone diisocyanate with a method based on the preparation specification for polyurea 1. This gave a polyurea solution with solids content of 29.3% by weight and a calculated content of 4.63 mol/kg of urea groups and a content of 2.31 mol/kg of anionic groups.

### Example 3

### Polyurethane made from Isophorone Diisocyanate and Dimethylolpropionic Acid

67.0 g (0.50 mol) of dimethylolpropionic acid in 210 g of acetone are heated to reflux in a four-necked flask equipped with stirrer, dropping funnel, thermometer, and reflux condenser. 111.1 g (0.5 mol) of isophorone diisocyanate were added to the mixture. After reflux for two hours, 37.5 g (0.375 mol; 75 mol%, based on DMPA) of triethylamine were added. 300 g of water were then added, and the acetone was distilled off at subatmospheric ressure. This gave a polyurethane solution with a solids content of 38% by weight, with a calculated content of 4.64 mol/kg of rethane groups, and with a content of 1.74 mol/kg of anionic groups.

### III. Performance-related Examples

### III.1 Contact Angle Measurement

Contact angle was measured as described above. The results are given in Table 1 below.

TABLE 1

| | | Contact |
|---|---|---|
| Example No. | Additive | angle |
| 1 (comparison) | No additive | 105° |
| 2 (comparison) | Commercially available alcohol | 58° |
| | ethoxylate | |
| 3 (comparison) | Commercially available hydrophilicizing | 86° |
| | polyetherester | |
| 4 | Example 1 | 1° |
| 5 | Example 2 | 8° |
| 6 | Example 3 | 50° |

Hydrophilic properties were measured as described above. The results are given in Table 2 below.

TABLE 2

| | | Hydrophilic |
|---|---|---|
| Example No. | Additive | properties |
| 7 (comparison) | No additive | 0 |
| 8 (comparison) | Commercially available | 3 |
| | hydrophilicizing polyetherester | |
| 9 | Example 1 | 9 |
| 10 | Example 2 | 10 |
| 11 | Example 3 | 9 |

Affinity was determined as described above. The results are given in Table 3 below.

TABLE 3

| Example No. | Additive | Affinity |
|---|---|---|
| 12 (comparison) | Commercially | removed by rinsing with |
| | available | water |
| | polycarboxylate | |
| 13 | Example 1 | remains on the PP layer on |
| | | rinsing with water |
| 14 | Example 2 | remains on the PP layer on |
| | | rinsing with water |
| 15 | Example 3 | remains on the PP layer on |
| | | rinsing with water |

The performance-related examples show that polypropylene surfaces can be effectively hydrophilicized using the polymers of the invention or the polymers used according to the invention. None of the inventive examples here reveals any significant tendency toward foaming, whereas the commercially available alcohol ethoxylate used as comparative substance shows a marked to very marked foaming tendency, as do the conventional nonionic surfactants known from the prior art. When the polymers are used moreover no significant reduction is found in the surface tension of an aqueous solution, whereas the alcohol ethoxylate used as comparative substance markedly reduces the surface tension, as do very generally the surfactants known from the prior art and used as hydrophilicizing agents.

We claim:

1. A particulate, linear, sheet-like, or three-dimensional structure comprising, at least on its surface, a hydrophilicizing amount of at least one polymer which has urethane groups and/or urea groups, and also anionic groups, where the content of urethane groups and/or urea groups is at least 2 mol/kg of polymer and where the polymer has a content of from 0.5 to 5 mol/kg of anionic groups.

2. A structure as claimed in any of the preceding claims in the form of a linear or sheet-like textile.

3. A structure as claimed in claim 2, in which the textile has been built up from synthetic fibers.

4. A structure as claimed in claim 1 in the form of a plastic film or of a plastic molding.

5. A structure as claimed in any of the preceding claims, where the polymer is obtained from
a) at least one polyisocyanate,
b) at least one compound having at least one group reactive toward isocyanate groups and also having at least one group which is anionic or capable of conversion into an anionic group,
and also, where appropriate, from at least one other compound which differs from b) and has at least one group reactive toward isocyanate groups,
where component b) has at least one compound having at least one anionic group, or where at least some of the groups capable of conversion into anionic groups in the polymer are present in the form of the products of their reaction with at least one neutralizing agent.

6. A structure as claimed in claim 5, where the ratio of NCO equivalents of component a) to active hydrogen atom equivalents of components b) and, where appropriate, of addition compounds is in the range from 0.9:1 to 1.1:1.

7. The use of polymers which have urethane groups and/or urea groups, and also anionic groups, where the content of urethane groups and/or urea groups is at least 2 mol/kg of polymer and where the polymer has a content of from 0.5 to 5 mol/kg of anionic groups, and which are obtained from
a) at least one polyisocyanate,
b) at least one compound having at least one group reactive toward isocyanate groups and also having at least one group which is anionic or capable of conversion into an anionic group,
and also, where appropriate, from at least one other compound which differs from b) and has at least one group reactive toward isocyanate groups,
where component b) has at least one compound having at least one anionic group, or where at least some of the groups capable of conversion into anionic groups in the polymer are present in the form of the products of their reaction with at least one neutralizing agent, for modifying the surface properties of solids.

8. A process for modifying the surface properties of particulate, linear, sheet-like, or three-dimensional structures, by applying, to the surface of these, an effective amount of a polymer which has urethane groups and/or urea groups, and also anionic groups, where the content of urethane groups and/or urea groups is at least 2 mol/kg of polymer and where the polymer has a content of from 0.5 to 5 mol/kg of anionic groups, and which is obtained from
a) at least one polyisocyanate,
b) at least one compound having at least one group reactive toward isocyanate groups and also having at least one group which is anionic or capable of conversion into an anionic group,
and also, where appropriate, from at least one other compound which differs from b) and has at least one group reactive toward isocyanate groups,
where component b) has at least one compound having at least one anionic group, or where at least some of the groups capable of conversion into anionic groups in the polymer are present in the form of the products of their reaction with at least one neutralizing agent.

9. A process for modifying the surface properties of particulate, linear, sheet-like, or three-dimensional structures, by modifying the material of which the structure is composed with an effective amount of a polymer which has urethane groups and/or urea groups, and also anionic groups, where the content of urethane groups and/or urea groups is at least 2 mol/kg of polymer and where the polymer has a content of from 0.5 to 5 mol/kg of anionic groups which is obtained from
a) at least one polyisocyanate,
b) at least one compound having at least one group reactive toward isocyanate groups and also having at least one group which is anionic or capable of conversion into an anionic group,
and also, where appropriate, from at least one other compound which differs from b) and has at least one group reactive toward isocyanate groups,
where component b) has at least one compound having at least one anionic group, or where at least some of the groups capable of conversion into anionic groups in the polymer are present in the form of the products of their reaction with at least one neutralizing agent, and producing the structure therefrom.
